(19) United States
(12) Patent Application Publication
(10) Pub. No.: US 2020/0007832 A1
(43) Pub. Date: Jan. 2, 2020

(54) PROJECTOR, COMPUTER READABLE MEMORY MEDIUM, AND DISPLAY SYSTEM

(71) Applicant: CASIO COMPUTER CO., LTD., Tokyo (JP)

(72) Inventor: Atsushi NAKAGAWA, Tokyo (JP)

(73) Assignee: CASIO COMPUTER CO., LTD., Tokyo (JP)

(21) Appl. No.: 16/456,814

(22) Filed: Jun. 28, 2019

(30) Foreign Application Priority Data
Jul. 2, 2018 (JP) 2018-125707

(51) Int. Cl. H04N 9/31; G06F 3/14

(52) U.S. Cl. CPC H04N 9/3179; G06F 3/04842; G06F 3/14

(57) ABSTRACT

A projector according to an aspect of the present invention includes a projection unit and a processor configured to execute functions as below, wherein the processor functions to acquire image information, select part of an image included in the image information as a display subject image, and cause the projection unit to project the display subject image so selected and an image synthesizing area image indicating an image synthesizing area.

### CROSS-REFERENCE TO RELATED APPLICATION

This application is based upon and claims the benefit of priority under 35 USC 119 of Japanese Patent Application No. 2018-125707 filed on Jul. 2, 2018, the entire disclosure of which, including the description, claims, drawings, and abstract, is incorporated herein by reference in its entirety.

### BACKGROUND OF THE INVENTION

### Field of the Invention

The present invention relates to a projector, a computer readable memory medium, and a display system.

### Description of the Related Art

Projectors are widely used on many occasions in these days for projecting a screen of a personal computer, a video screen, and further, an image based on image data recorded on a memory card or the like onto a screen. In these projectors, light emitted from a light source is collected onto a micromirror display device called a digital micromirror device (DMD) or a liquid crystal panel to thereafter display a color image onto the screen.

In these projectors, a technique is proposed in which a projection range is changed according to a change in projection environment. For example, Japanese Patent Laid-Open No. 2017-167500 discloses a projector in which with a posture staying within a predetermined range, input images are projected as they are, whereas with the posture staying out of the predetermined range, input images are projected with one of the input images being disposed on an upper side of a projection range. As a result of this, the projector can continue to operate with an optimal projecting performance while responding quickly to a change in projection environment without involving complex and troublesome operations.

In Japanese Patent Laid-Open No. 2017-167500, however, since the image that the projector projects is an overall image displayed on a personal computer, an unnecessary image in the overall image is sometimes projected on a projection target object, and this makes it difficult from time to time for the operator to make an additional handwritten description on a projected image in parallel with projection of images that the operator desires to project.

### SUMMARY OF THE INVENTION

An object of the present invention is to provide a projector that facilitates a parallel use of a display subject image with a display by another projection device, a computer readable memory medium, and a display system.

According to an aspect of the present invention, there is provided a projector including a projection unit and a processor configured to execute functions as below, wherein the processor functions to acquire image information, select part of an image included in the image information as a display subject image, and cause the projection unit to project the display subject image so selected and an image synthesizing area image indicating an image synthesizing area.

According to another aspect of the present invention, there is provided a computer readable memory medium configured to control a projector including a control unit, the computer readable memory medium causing the control unit to execute processing of acquiring image information, selecting part of an image included in the image information as a display subject image, and causing a projection unit to project the display subject image so selected and an image synthesizing area image indicating an image synthesizing area.

According to a further aspect of the present invention, there is provided a display system for a plurality of terminals each including a display unit, the display system including: a communication unit configured to transmit positional information on a display position of a display frame of a predetermined application in applications to be displayed on the display unit of the terminal or a display frame of an application selected by an operation of a user and image information corresponding to the positional information; a memory unit configured to store the image information and the positional information that are transmitted from another terminal and received via the communication unit; and a control unit configured to select part of an image included in the image information stored in the memory unit as a display subject image, and display the display subject image so selected and an image synthesizing area image indicating an image synthesizing area.

### BRIEF DESCRIPTION OF THE DRAWINGS

FIG. 1 is a diagram showing a schematic configuration of a projection system according to a first embodiment of the present invention;

FIG. 2 is a block diagram showing the configuration of the projection system according to the first embodiment of the present invention;

FIG. 3 is a diagram showing a flow chart of processing executed at a terminal according to the first embodiment of the present invention;

FIG. 4 is a diagram showing a flow chart of processing executed in a projector according to the first embodiment of the present invention;

FIG. 5 is a schematic diagram of a display unit of the terminal according to the first embodiment of the present invention;

FIG. 6A is a diagram showing a projected image projected on a screen according to the first embodiment of the present invention, showing an example in which a black image is projected on a descriptive area;

FIG. 6B is a diagram showing a projected image projected on a screen according to a second embodiment of the present invention, showing an example in which a ruled line image is projected on a descriptive area;

FIG. 7 is a diagram showing another example in which a part is selected from a plurality of windows on a display unit according to the embodiment of the present invention;

FIG. 8A is a diagram showing a further example in which a certain area is selected from a window according to the embodiment of the present invention;

FIG. 8B is a diagram showing a projected image projected on a screen by selecting part of the window of the display unit according to the embodiment of the present invention; and

FIG. 9 is diagram showing another display unit according to the embodiment of the invention.

### DETAILED DESCRIPTION OF THE PREFERRED EMBODIMENTS

### First Embodiment

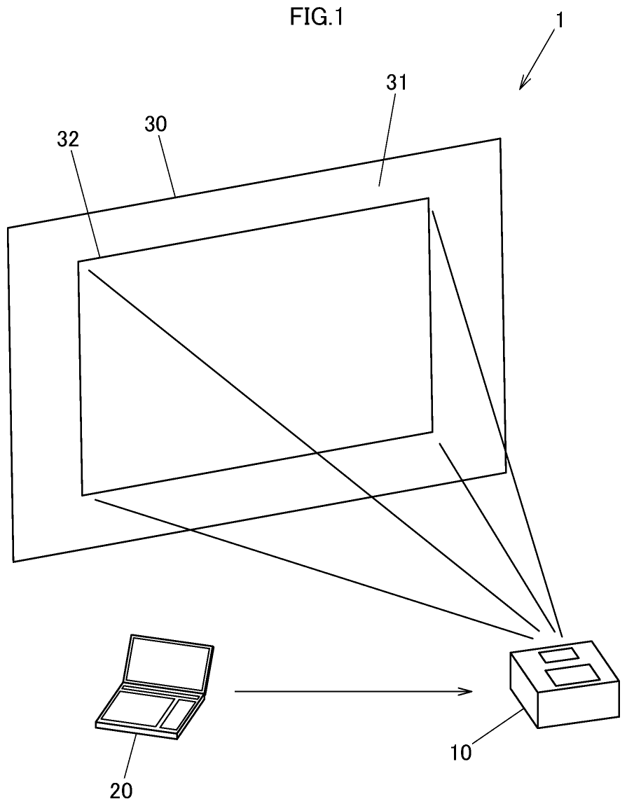

Hereinafter, a mode for carrying out the present invention will be described. FIG. 1 is a diagram showing a schematic configuration of a projection system 1. The projection system 1 includes a projector 10, which is an electronic device for projecting an image on a projection plane 31 of a projection target object 30, and a terminal 20 for transmitting image information including a projection subject image to the projector 10. A personal computer, a video camera, a smartphone (a highly functional mobile telephone), or a tablet terminal can be used as the terminal 20. The projection target object 30 can be a screen, a whiteboard, an electronic blackboard, or a wall surface that can diffuse and reflect projection light projected thereon while allowing a user to write thereon using a manual writing tool such as a marker.

The operation of the projection system 1 will briefly be described. The projector 10 of this embodiment receives image information transmitted thereto from the terminal 20. The projector 10 cuts apart a certain display subject image from the received image information and superposes the display subject image so cut apart on a descriptive image that is set in advance for projection on a projection enabling area 32 of the projection target object 30. The user manually writes characters and/or figures on the area on the projection target object 30 where the descriptive image is displayed to provide viewers with information in parallel with the display subject image.

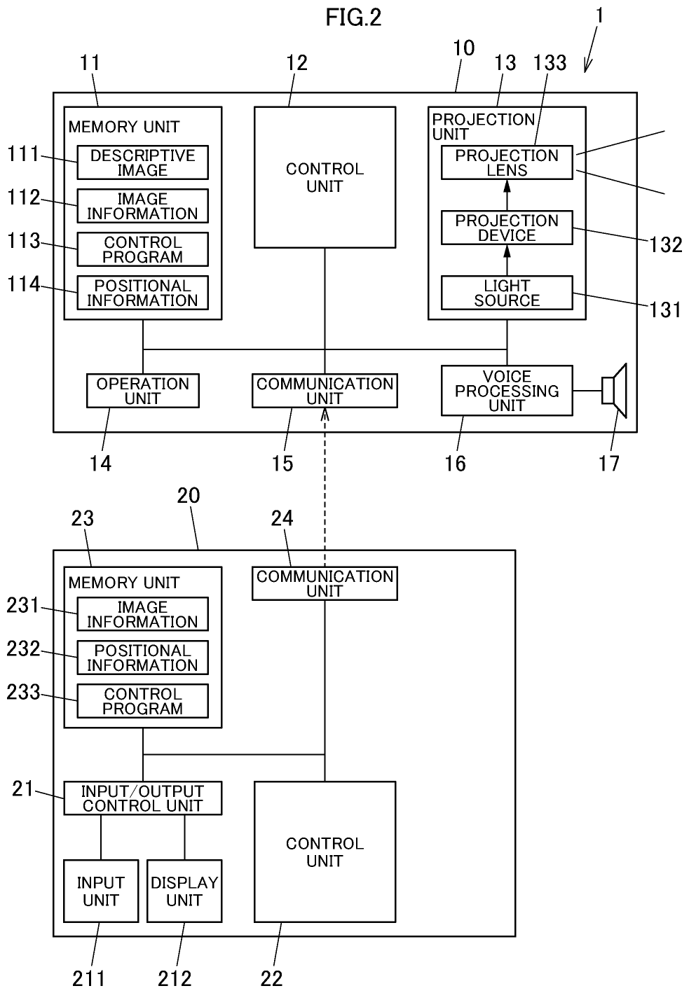

FIG. 2 is a diagram showing the configuration of the projection system 1. The projector 10 includes a memory unit 11, a control unit 12 (a selection device, a projection control device), a projection unit 13 (a projection device, a display device), an operation unit 14, a communication unit 15, and a voice processing unit 16, and these constituent units are connected together by an internal bus. The memory unit 11 is made up, for example, of a solid state drive (SSD) or a static random access memory (SRAM). The memory unit 11 stores a descriptive image 111 (an image synthesizing area image) indicating a handwriting area, image information 112 received from the terminal 20, a control program 113 of the projector 10, and positional information 114 received from the terminal 20.

The control unit 12 reads out the control program 113 stored in the memory unit 11 and controls the projector 10 in a supervisory fashion. The control unit 12 acquires the image information 112 from the memory unit 11, selects a certain area of the image as a display subject image 231a, which will be described later, and superposes the selected image and the descriptive image 111 stored in the memory unit 11 on each other, transmitting the superposed image to the projection unit 13.

The projection unit 13 projects the image (the display subject image 231a and the descriptive image 111) sent from the control unit 12 at a frame rate conforming to a preset image format. A light source 131 of the projection unit 13 includes an LED or LD (laser diode) which is a semiconductor light emitting device and shines light source light made up of light in the red, green, and blue wavelength ranges on to a projection device 132. A digital micromirror device (DMD) is used for the projection device 132, and this projection device 132 can display light in the red wavelength range, light in the green wavelength range, and light in the blue wavelength range in a time-sharing fashion according to image data to be projected to thereby project a color image on to the projection target object 30 via a projection lens 133. A different system such as alight liquid projector may be used for the projection device 132. An image projected from the projection unit 13 is projected on to the projection enabling area 32 of the projection plane 31 shown in FIG. 1.

The operation unit 14 receives operation signals from operation keys provided on a casing of the projector 10 and transmits the operation signals to the control unit 12 via the bus. The control unit 12 executes various functions such as a function to execute the processing of projection in response to an operation signal from the operation unit 14.

The communication unit 15 (an acquisition device) can exchange data with a communicate unit 24 of the terminal 20. The communication unit 15 receives an operation signal such as an infrared modulation signal from a remote controller, not shown, and transmits the operation signal to the control unit 12. The communication unit 15 can include an external input terminal, so that viewable image data can be input into the communication unit 15 from an external device. In this embodiment, although the communication unit 15 communicates with the communication unit 24 wirelessly, a communication via a cable may be executed therebetween.

The voice processing unit 16 includes a sound source circuit such as a PCM sound source and drives a speaker 17 to emit and spread sound. In the case where image data to be projected contains a voice signal, the voice processing unit 16 transforms the voice signal into an analog signal so as to output sound via the speaker 17 when the image data is projected.

The terminal 20 includes an input/output control unit 21, a control unit 22, a memory unit 23, and the communication unit 24, and these constituent units are connected together by an internal bus.

The input/output control unit 21 transmits an instruction that the user inputs from an input unit 211 to the control unit 22. The input unit 211 can be, for example, a keyboard or a mouse. A display unit 212 is a liquid crystal screen on which an image output from the input/output control unit 21. The terminal 20 may include a touch panel display having a function to act as the input unit 211 and the display unit 212.

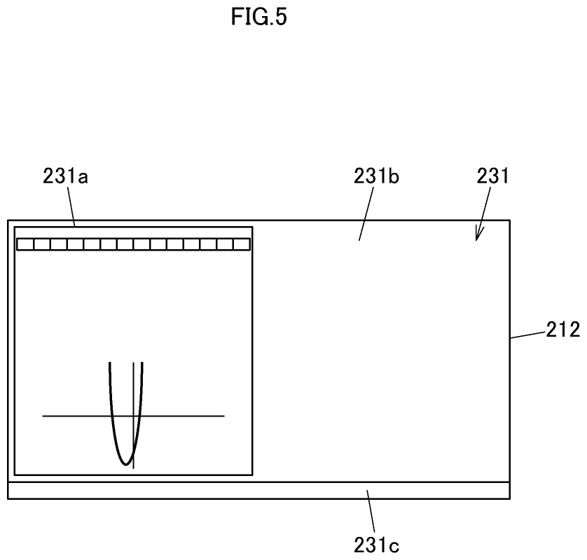

The memory unit 23 stores image information 231, positional information 232, and a control program 233. The image information 231 includes a display subject image 231a and non-display subject images 231b, 231c (refer to FIG. 5). The positional information 232 is information configured to specify a position (an area) of the display subject image 231a in an image that is displayed on the display unit 212 based on the image information 231.

The control unit 22 reads out the control program 233 stored in the memory unit 23 and controls the terminal 20 in a supervisory fashion. The control unit 22 transmits the image information 231 and the positional information 232 to the projector 10 via the communication unit 24.

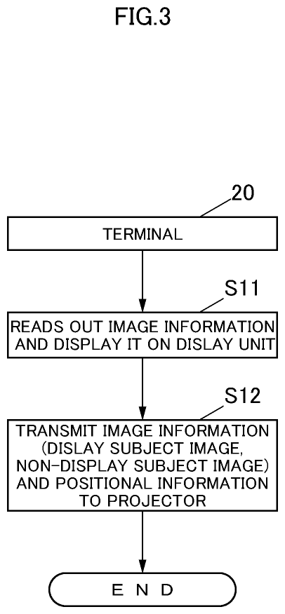

Next, referring to FIGS. 3 to 6, a projection method using the projector 10 and the terminal 20 will be described. FIG. 3 is a diagram showing a flow chart of processing executed in the terminal 20. In step S11, the control unit 22 reads out the image information 231 stored in the memory unit 23 and causes the input/output control unit 21 to display the image information 231 so read out on the display unit 212. The image information 231 that is displayed on the display unit 212 includes the display subject image 231a that is projected by the projector 10 and the non-display subject images 231b, 231c that are not projected by the projector 10, as shown in FIG. 5 as an example. The display subject image 231a of this embodiment is a display frame (a window frame) of a specific application that is to be executed by the terminal 20 and is disposed on a left side of the display unit 212. The non-display subject image 231b shown in FIG. 5 as an example is a background image of the terminal 20. In addition, the non-display subject image 231c is a menu image corresponding to the functions of the terminal 20. Although display frames of a plurality of applications may sometimes be displayed on the display unit 212 of the terminal 20, the display subject image 231a can be a display frame of a certain application, and the non-display subject image 231b can be a display frame of a different application.

In step S12, the control unit 22 transmits the image information 231 (the display subject information 231a and the non-display subject images 231b, 231c) and the positional information 232 that are caused to be displayed on the display unit 212 to the projector 10 via the communication unit 24. A timing at which the control unit 22 transmits the image information 231 and the positional information 232 may be instructed manually by the user using the input unit 211 or may be a timing at which the terminal 20 establishes a communication with the projector 10. The positional information 232 of the display subject image 231a can be a display position of a display frame of a predetermined specific application that is displayed on the display unit 212. The positional information 232 may be a display position of an active display frame in the images displayed on the display unit 212 of the terminal 20. The display position can be a coordinate within an image displayed on the display unit 212. The positional information 232 of the display subject image 231a may be nullified when the display subject image 231a is non-active or non-displayed.

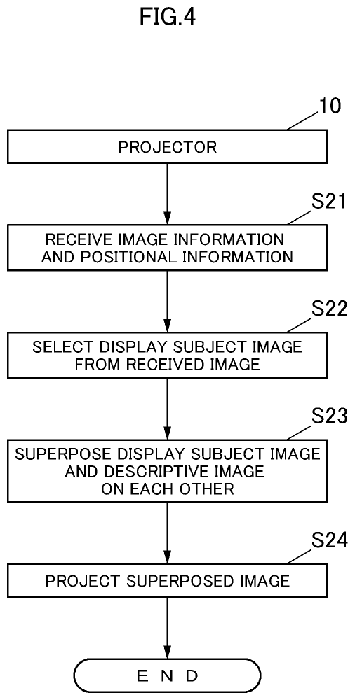

FIG. 4 is a diagram showing a flow chart of the projector 10. In step S21 (an acquiring step), the control unit 12 receives the image information 231 and the positional information 232 that are transmitted from the terminal 12 via the communication unit 15. The control unit 12 stores the received image information 231 as the image information 112 in the memory unit 11. The control unit 12 stores the positional information 232 as the positional information 114 in the memory unit 11.

In step S22 (a selection step), the control unit 12 selects an image of an area that is specified from the image information 112 that is transmitted from the terminal 20 and stored in the memory unit 11 by the positional information 114 and cuts apart the image so selected from the image information 112 as a display subject image 231a. The control unit 12 can specify the display subject image 231a included in the image information 112 from a coordinate indicated by the positional information 114.

In step S23, the control unit 12 acquires a descriptive image 111 from the memory unit 11 and superposes the descriptive image 111 so acquired on the display subject image 231a that is cut apart from the image information 112 in step S22. The descriptive image 111 acquired in this embodiment is a black image 111a resulting from the projection light being switched off.

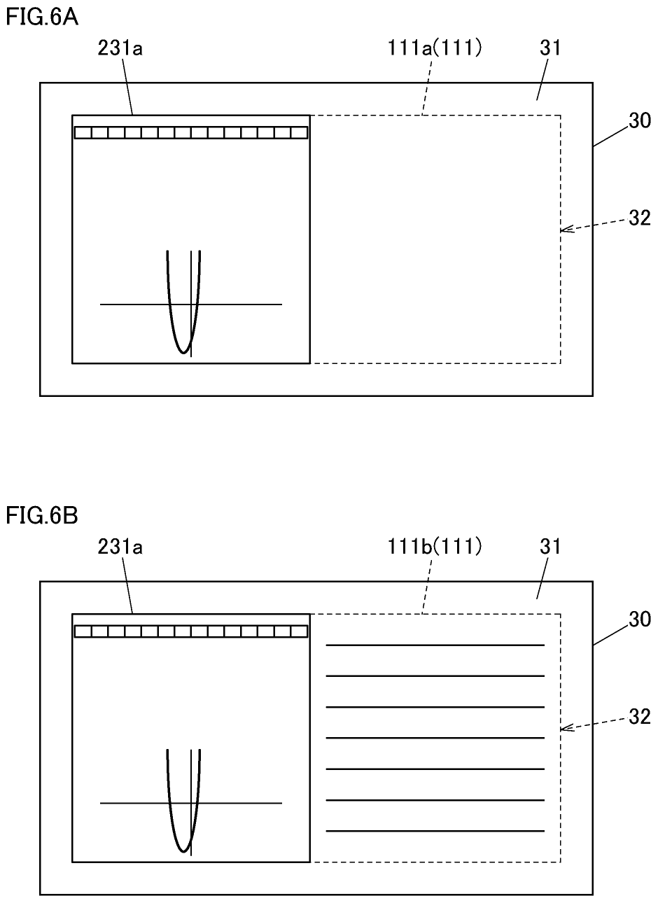

In step S24 (a projection step), the control unit 12 causes the projection unit 13 to project the image resulting from the superposition in step S23 as a projection image. FIG. 6A shows an example in which the control unit 12 projects the display subject image 231a and the black image 111a (111) on the projection enabling area 32 of the projection target object 30. Since the user can not only display the projection image on the projection target object 30 but also handwrite information on the projection target object 30 with a wiring tool such as a marker, the user can handwrite information on the area of the black image 111a that lies adjacent to the display subject image 231a with the wiring tool. If the positional information 232 is nullified in step S12 in FIG. 3 (for example, if “0” is input for the value of the positional information 232), the control unit 12 may cause the projection unit 13 to display only the descriptive image 111 in step S24 without cutting apart the display subject image 231a in step S22 and superposing the display subject image 231a on the descriptive image 111 in step S23.

The projector 10 may project a grey image or a white image, which is illumination light, in addition to the black image 111a as the descriptive image 111. The grey image and the white image can be set at such a degree of brightness as to ensure a contrast between characters and a background color that facilitates the visual discrimination of the characters described on the projection target object 30 from the background thereof. The brightness of the grey image and the white image can be set arbitrarily according to an illumination environment surrounding the periphery of the projector 10.

### Second Embodiment

Next, a second embodiment of the present invention will be described. In this embodiment, an example will be described in which an image different from that of the first embodiment is projected as a descriptive image 111. In the description of the second embodiment, like reference signs will be given to like configurations to those of the first embodiment, and the description thereof will be omitted or simplified.

A projector 10 can project an image supporting handwritten information by a user on to a descriptive image 111. For example, the projector 10 can store a horizontal writing ruled line image 111b in which a plurality of horizontal lines are arranged as a descriptive image 111 of a projection image projected on a projection target object 30 in a storage unit 11. FIG. 6B is a diagram showing an example in which the horizontal writing ruled line image 111b is projected as the descriptive image 111. A background area excluding ruled lines in the horizontal writing ruled line image 111b can be a black image, a grey image or a white image. The user can reduce a risk of the visibility of characters being interrupted by the projection light while improving the appearance of described characters by projecting the horizontal writing ruled line image 111b.

In addition, the descriptive image 111 supporting the writing is not limited to the horizontal writing ruled line image 111b, and hence, various modes can be applied. For example, an arbitrary image such as a vertical writing ruled line image, a cell image in which a plurality of cells are arranged in a horizontal direction or a vertical direction for horizontal writing or vertical writing, a grid image in which a plurality of dots or dot-like images are arranged at equal intervals vertically and horizontally, or an axis image such as a number line or a Cartesian coordinate system can be applied to the descriptive image 111. In the horizontal writing ruled line image 111b or a vertical writing ruled line image, a plurality of different types of lines may be disposed within a row. One type of or a plurality of types of lines may be displayed in the descriptive image 111 as described above.

The descriptive image 111 can be set according to a subject of a class at school, or images that differ from country to country or from region to region where classes are held can be set.

As has been described heretofore, in this embodiment, the appearance of characters can be improved by displaying lines or dots in the descriptive image 111. By displaying ruled lines or grids digitally as the descriptive image 111, characters can be handwritten quickly on the descriptive image 111 to thereby prevent time from being lost or spent wastefully, or the visibility of the handwritten characters can be improved.

In addition, according to the embodiments of the present invention, in a scene where in a class at school, a teacher explains by handwriting characters or the like on a projection target object 30 such as a whiteboard while displaying a digital tool from the projector the projector 10, a drawback can be eliminated in that the visibility of handwritten characters is deteriorated as a result of the image that is desired to be displayed and the image that is not desired to be displayed (for example, a background or a tool bar of a desk top computer) being projected simultaneously.

As a result of the configuration where the terminal 20 transmits image information to the projector 10 wirelessly, even when the terminal 20 is used in such a way that a teacher brings in the terminal 20 such as a notebook-sized personal computer every time he or she explains in his or her class, the number of labor hours or trouble in connecting the terminal 20 with the projector 10 with a cable can be reduced, thereby making it possible to enhance the usefulness or convenience of the display system 1.

The terminal 20 can be configured so as not to transmit the positional information 232. In this case, in step S12 in FIG. 3, the terminal 20 transmits the image information 231 (the display subject image 231a and the non-display subject images 231b, 231c) to the projector 10. After having received the image information 231 in step S21, the projector 10 cuts apart (extracts) the display subject image 231a from the image information 231 through image analysis in step S22. As an image analyzing method, for example, a method may be adopted in which the luminance brightness of a contour portion of the display subject image 231a of the image information 231 is left relatively higher or lower than those of images on the periphery, and the projector 10 binarizes the image of the image information 231 to allow an edge of a contour of the contour portion to be detected and determines an area surrounded by the contour as the area of the display subject image 231a. Then, the projector 10 superposes the display subject image 231a detected in step S22 and the descriptive image 111 on each other (step S23) and can project the resulting superposed image on to the projection target object 30 (step S24).

The positional information 232 that the terminal 20 transmits in step S12 in FIG. 3 may be information that the user inputs in advance through the input unit 211 to be acquired by the terminal 20. For example, the user may confirm an image displayed on the display unit 212 of the terminal 20 and designate an area of the image that the user desires to project from the projector 10 through the input unit 211.

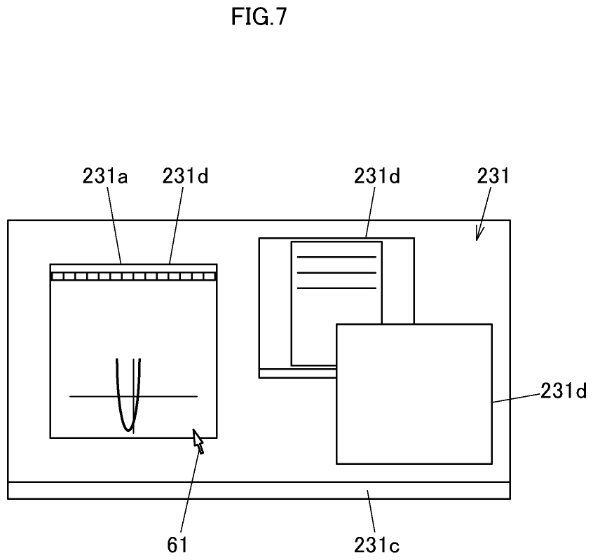

As an example, in the case where windows 231d of a plurality of applications are displayed on the display unit 212 of the terminal 20, an image that the user desires to display as the display subject image 231a may be selected through a click operation of the mouse or a keyboard operation. In FIG. 7, a state is shown in which a left window 231d in a plurality of windows 231d is selected as the display subject image 231a using a cursor 61. At this time, the display mode of a frame of the window 231d may be changed in such a way that the color of the frame of the selected window 231d changes or the thickness of the frame of the selected window 231d is increased so that the user can recognize the selected window 231d.

In the case where the terminal 20 includes a touch panel display through which the user can input information as the display unit 212, a window 231d may be selected as the display subject image 231a by an input made through a touch operation by the user. In this way, the display subject image 231a is selected through the designating operation by the user, and the positional information 232 that specifies the position (area) of the display subject image 231a is transmitted via the communication unit 24.

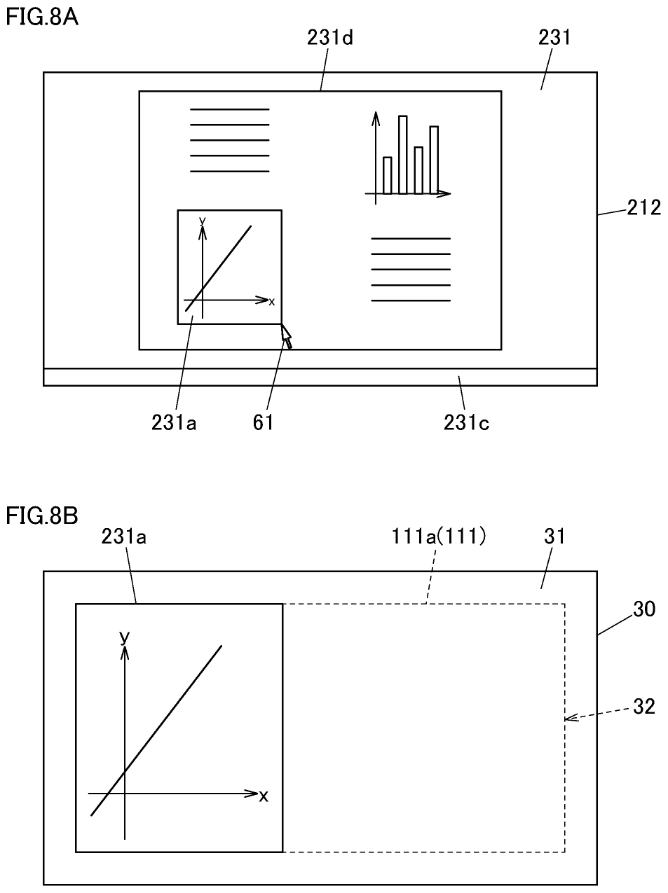

In addition, an image or an area that the user desires to display as the display subject image 231a may be selected through a drag operation of the mouse by the user. FIG. 8A is a diagram in which one window 231d is displayed on the display unit 212 of the terminal 20. The user can select one area in the one window 231d as the display subject image 231a. In FIG. 8A, a graph at a bottom left-hand side corner is shown as being selected as the display subject information 231a through a drag operation of the cursor 61 by the user.

FIG. 8B shows an example in which the display subject image 231a, which is selected through the operation illustrated in FIG. 8A, is projected together with a black image 111a, which is the descriptive image 111, on the projection enabling area 32 of the projection target object 30. In this way, the one area in the window 231d may be displayed as the display subject image 231a together with the black image 111a. In this case, too, as in the example described above, the positional information 232 that specifies the position (area) of the display subject image 231a selected through the designating operation by the user is transmitted from the terminal 20 to the projector 10 via the communication unit 24.

A position where the display subject image 231a is projected can be arranged in a reduced area based on a top left-hand side corner, a bottom left-hand side corner, a top right-hand side corner, or a bottom right-hand side corner of the projection enabling area 32. Then, the projector 10 can project the descriptive image 111 on the other area of the projection enabling area 32 where the display subject image 231a is not displayed.

A configuration may also be adopted in which the projector 10 stores a plurality of different descriptive images 111 in advance in the memory unit 11, so that the user selects a descriptive image 111 that the user desires to display together with the display subject image 231a.

In addition, in the embodiments, although the descriptive image 111 is described as being the image that the user desires to display together with the display subject image 231a, an image synthesizing area image showing an image synthesizing area where the display subject image 231a is synthesized with an image other than the descriptive image 111 may be displayed. The image synthesizing area image can be a black image, a grey image or a white image, or one or a plurality of frame image. The image synthesizing area image can be stored in advance in the memory unit 11 as with the descriptive image 111. The display or image other than the descriptive image 111 can be an image that is output to be displayed through projection from another device.

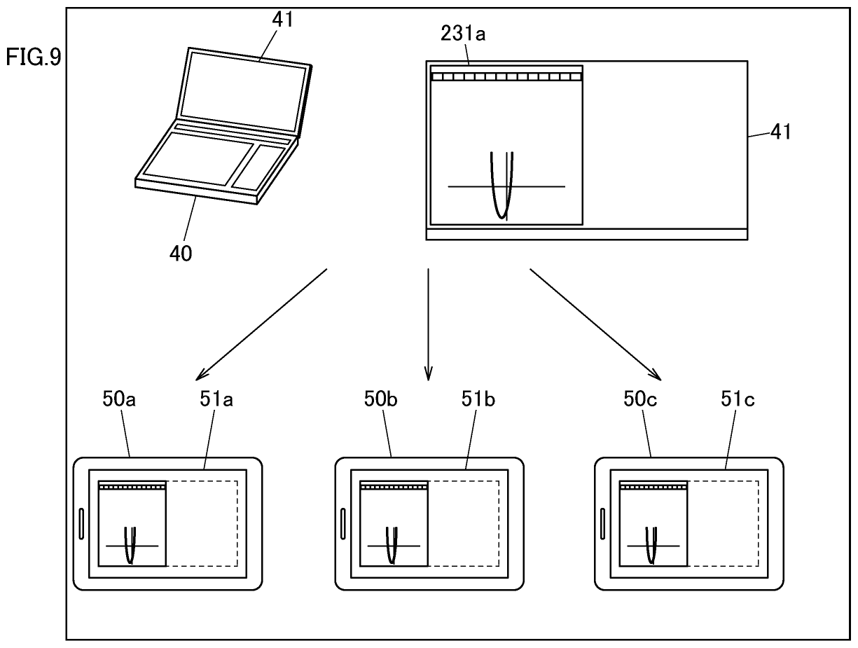

The projector 10 may be an electronic device configured to acquire the image information 231 from the terminal 20 and display the display subject image 231a and the image synthesizing area image on a display unit (a display device). For example, a display system 1 of the embodiments can also be applied to the display system 1 in which part of a screen of a personal computer 40 or a tablet terminal for a teacher is shared with one or a plurality of tablets 50a, 50b, 50c for pupils. FIG. 9 shows the personal computer 40 for a teacher, an image displayed on a display unit 41 of the personal computer 40, the tablets 50a, 50b, 50c, and images displayed on display units 51a, 51b, 51c of the tablets 50a, 50b, 50c for pupils. The tablets 50a, 50b, 50c for pupils may acquire the image information 231 from the personal computer 40 for a teacher to display the display subject image 231a and the image synthesizing area image on the display unit 51a, 51b, 51c (display devices).

Thus, the projector 10 according to the embodiments of the present invention is configured to include an acquisition device configured to acquire the image information 231, a selection device configured to select part of the image included in the image information 231 as the display subject image 231a, and a display control device configured to display the display subject image 231a selected by the selection device and the image synthesizing area image showing the image synthesizing area on a display device. Due to this, according to the embodiments, an electronic device (the projector 10) can be provided which facilitates the use of the display subject image in parallel with the display by the other device or devices. Consequently, according to the embodiments, a display device (for example, a personal computer or a tablet terminal) can also be provided which includes a display screen configured to display the image included in the image information 231.

The acquisition device acquires the positional information 232 of the display subject image 231a together with the image information 231 from the terminal 20, selects the image of the area specified by the positional information 232 from the image information 231 and cuts apart the image in question from the image information 231 as the display subject image 231a. Due to this, the electronic device can easily cut apart the display subject image 231a from the image information 231.

The positional information 232 is the display position of the display frame of the predetermined application or the active display frame in the images displayed on the display unit 212 of the terminal 20. This enables the unnecessary image area to be excluded easily from the display subject image for projection.

The electronic device includes further the memory unit 11 configured to store in advance the image synthesizing area image, and the display control device superposes the display subject image 231a and the image synthesizing area image acquired from the memory unit 11 on each other for display. This facilitates the acquisition of the image synthesizing area image and the superposition of the image synthesizing area image so acquired on the display subject image 231a.

In the case where the image synthesizing area image is the descriptive image showing the handwriting area, the display of the handwriting made to be added to the display subject image 231a by the user can be visualized while displaying the display subject image 231a. Due to this, even in an environment like a classroom where a white board cannot be used as a screen, in the case where a teaching is executed where a digital image is used in parallel with a handwriting, the background of the projector 10 or a window or a tool bar of an application that the user does not desire to display can be prevented from being displayed, thereby making it possible to improve the visibility of the handwritten characters or the like.

The display control device projects part or some of the black image, the grey image, the white image, the ruled line image, the cell image, the grid image and the axis image. Due to this, the descriptive image 111, which is suitable for the environment where the user uses the display system or the display subject image 231a that is to be displayed, can be displayed in parallel with the display subject image 231a.

In the electronic device where the acquisition device is the communication unit 15 configured to acquire the image information 231 wirelessly, the image information 231 and the positional information 232 can easily be acquired. Consequently, the display subject image 231a can easily be cut apart from the image that the image information 231 includes.

The projector 10 includes an acquisition device configured to acquire image information, a selection device configured to select part of an image included in the image information 231 as the display subject image 231a, and a projection control device configured to project the display subject image 231a selected by the selection device and an image synthesizing area image indicating an image synthesizing area by a projection device. This can facilitate the use of the display subject image in parallel with the display by another device.

A projection method for the projector 10 includes an acquisition step of acquiring the image information 231, a selection step of selecting part of an image included in the image information 231 as the display subject image 231a, and a projection step of projecting the display subject image 231a selected in the selection step and an image synthesizing area image indicating an image synthesizing area using a projection device. This can facilitate the use of the display subject image in parallel with the display by another device.

A program that is executed by the computer (the projector 10) causes the computer to function as an acquisition device configured to acquire image information, a selection device configured to select part of an image included in the image information as the display subject image 231a, and a projection control device configured to project the display subject image 231a selected by the selection device and an image synthesizing area image indicating an image synthesizing area using a projection device. This can facilitate the use of the display subject image in parallel with the display by another device.

While the embodiments of the present invention have been described heretofore, the embodiments are presented as examples, and hence, there is no intention to limit the scope of the present invention by the embodiments. These novel embodiments can be carried out in other various forms, and various omissions, replacements and modifications can be made to the embodiments without departing from the spirit and scope of the invention. Those resulting embodiments and their modifications are included in the spirit and scope of the present invention and are also included in the scope of inventions claimed for patent under claims below and their equivalents.

What is claimed is:

1. A projector comprising:
a projection unit; and
a processor configured to execute functions as below,
wherein the processor functions to:
acquire image information;
select part of an image included in the image information as a display subject image; and
cause the projection unit to project the display subject image so selected and an image synthesizing area image indicating an image synthesizing area.

2. The projector according to claim 1, comprising:
a communication unit,
wherein the communication unit acquires positional information on the display subject image together with the image information from a terminal, and
wherein the processor selects an image of an area specified by the positional information from the image information and extracts the image as the display subject image.

3. The projector according to claim 2,
wherein the positional information constitutes a display position of a display frame of a predetermined application that is displayed on a display unit of the terminal.

4. The projector according to claim 2,
wherein the positional information constitutes a display position of a display frame of a display frame of an application that is displayed on a display unit of the terminal, the display frame being selected through an operation executed by a user.

5. The projector according to claim 1, comprising:
a memory unit configured to store the image synthesizing area image in advance,
wherein the processor superposes the display subject image and the image synthesizing area image acquired from the memory unit on each other and causes the projection unit to project a resulting superposed image.

6. The projector according to claim 1,
wherein the image synthesizing area image constitutes a descriptive image indicating a handwriting area.

7. The projector according to claim 6,
wherein the processor displays, as the descriptive image, part or some of a black image, a grey image, a white image, a ruled line image, a cell image, a grid image, and an axis image.

8. The projector according to claim 2,
wherein one area of an application in an image displayed on a display unit of the terminal is selected as the display subject image,
the communication unit receives positional information of the selected one area and the image information from the terminal, and
the processor selects an image of an area specified by the positional information from the image information and extracts the image as the display subject image.

9. The projector according to claim 2,
wherein in the case where the positional information is nullified,
the processor causes the projection unit not to project the display subject image but to project the image synthesizing area image.

10. A computer readable memory medium configured to control a projector comprising a control unit, the computer readable memory medium causing the control unit to execute processing of:
acquiring image information;
selecting part of an image included in the image information as a display subject image; and
causing a projection unit to project the display subject image so selected and an image synthesizing area image indicating an image synthesizing area.

11. A display system for a plurality of terminals each comprising a display unit, the display system comprising:
a communication unit configured to transmit positional information on a display position of a display frame of a predetermined application in applications to be displayed on the display unit of the terminal or a display frame of an application selected by an operation of a user and image information corresponding to the positional information;
a memory unit configured to store the image information and the positional information that are transmitted from another terminal and received via the communication unit; and
a control unit configured to;
select part of an image included in the image information stored in the memory unit as a display subject image, and
display the display subject image so selected and an image synthesizing area image indicating an image synthesizing area.

12. The display system according to claim 11,
wherein the control unit superposes the display subject image and the image synthesizing area image acquired from the memory unit on each other and displays a resulting superposed image on the display unit.

13. The display system projector according to claim 11,
wherein the image synthesizing area image constitutes a descriptive image indicating a handwriting area.

14. The display system according to claim 13,
wherein the control unit displays, as the descriptive image, part or some of a black image, a grey image, a white image, a ruled line image, a cell image, a grid image, and an axis image.

15. The display system according to claim 11,
wherein one area of an application in an image displayed on a display unit of the terminal is selected as the display subject image,
the communication unit receives positional information of the selected one area and the image information from the terminal, and
the control unit selects an image of an area specified by the positional information from the image information and extracts the image as the display subject image, and
displays the extracted display subject image and the image synthesizing area image on the display unit.

16. The display system according to claim 11,
wherein in the case where the positional information is nullified,
the control unit does not display the display subject image but displays the image synthesizing area image on the display unit.
